(19) United States
(12) Patent Application Publication
(10) Pub. No.: US 2004/0239615 A1
(43) Pub. Date: Dec. 2, 2004

(54) System and method for providing a computer user with alerts using a lighted mouse pad

(75) Inventors: Joseph E. Firebaugh, Apex, NC (US); Robert C. Leah, Cary, NC (US)

Correspondence Address: Gerald R. Woods, IBM Corporation T81/503, PO Box 12195, Research Triangle Park, NC, 27709, US

(73) Assignee: International Business Machines Corporation, Armonk, NY (US)

(21) Appl. No.: 10/445,705

(22) Filed: May 27, 2003

(51) Int. Cl. G09G 5/00

(52) U.S. Cl. 345/156

(57) ABSTRACT

A method and system for alerting a computer user about an event requiring user action using a lighted mouse pad. The lighted mouse pad is operable to lighting-up in one of several different light alert modes. Each light alert mode corresponds to a different type of event requiring the user's action. The different light alert modes include different parameters such as light of different color, intensity, flashing mode, etc. A user can assign different light alerts modes to each different type of event. In addition, a user can specify the conditions under which to enable the light alerts. The user can choose to completely disable or enable the alerts. Alternatively, the user can choose to enable the alerts only when the mute function has been activated, only when the screen saver function has been activated, or when either the mute or the screen saver functions have been activated.

### BACKGROUND OF THE INVENTION

1. Technical Field

The present invention relates in general to a system and method for a computer to alert a user to an event requiring the user's attention. In particular, the present invention relates to a system and a method for a computer to alert the user through a lighted mouse pad.

2. Description of the Related Art

Computer users, at times, must be alerted about events related to software running on the computer requiring user action. Often, these events require a user's immediate attention, and it is therefore critical that the alert captures the user's attention. Examples of such events include: the printer running out of paper or the paper jamming; the user needing to input information or needing to make a selection for a computer program or process to continue; another user or an administrator on the network sending a message; receiving new email; receiving a reminder about a scheduled event; error messages; etc.

Operating systems and computer software employ a variety of alerting techniques to ensure that a user is notified about an event requiring user action. Most of these techniques involve either audible or visual alerts. A simple alerting technique, for example, involves the sounding of a special beep through the computer's sound system. Many times, the beeps may be accompanied by pop-up windows that contain visual information indicating and describing the event. Other techniques involve flashing a window's title bar, temporarily altering objects (such as windows) on the screen, playing a message in speech format, etc.

Often, however, neither an audible alert nor an on-screen visual alert is effective. An audible alert may be ineffective, for example, if the user is hearing impaired. An audible alert can also be ineffective if a user has temporarily muted the computer's speakers. Visual alerts can also be ineffective. For example, a user may not be paying attention to the screen when the alert is created. More often, a visual alert is ineffective when the computer monitor is turned off, the computer monitor is in power-save mode, the screen saver has been activated, etc.

In addition, most alerts, even if noticed by the user do not immediately convey information as to the event type corresponding to the alert. Typically, a user is required to interface with the computer to discover the reason behind the alert.

What is needed, therefore, is a system and method that could more effectively provide alerts to a computer user. The system and method should provide the user with alerts that are more effective in capturing the user's attention and either supplement the existing alerts or provide an alternative means of delivering the alert. In addition, a system and method are needed that could provide the user with immediate information as to the event type requiring user action.

### SUMMARY

It has been discovered that the aforementioned challenges can be addressed by a method and a system that alerts a computer user about an event requiring user action with visible alerts from a lighted mouse pad. The lighted mouse pad can provide different types of visible alerts corresponding to different event types.

After receiving a request to alert a user about an event requiring user action, a light alert mode corresponding to the event type is determined. The different event types include “error message”, “warning message”, “information message”, “new email notification”, printer out of paper”, etc. The different light alert modes alert may differ in the color of the light, the intensity of the light, the flashing mode of the light, etc. The user may select a color, intensity, and flashing mode of light, for example, for each event type. The user's light alert mode preferences may be stored in a memory location and be used in determining the appropriate light alert mode for each event type. After a light alert mode is determined for the current event, an appropriate light signal is sent to the lighted mouse pad. The lighted mouse pad generates a visible alert in the appropriate color, intensity, and flashing mode.

The user may choose the conditions under which light alerts are enabled. The user can choose to completely disable the light alerts or the user may choose to enable the light alerts under all conditions. In addition, the user can choose conditions under which the light alerts are enabled. For example, the user may choose to enable the alerts only when the computer's mute function is active. Alternatively, the user can enable the alerts only when the computer's screen saver function is active. Other similar conditions may also be made available to the user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram of a computer system having a lighted mouse pad that provides a user with visible alerts when an event on the computer system requires user action;

FIG. 2 is a flowchart for prompting a user to input the user's light alert activation and light alert modes preferences;

FIG. 3 is a flowchart for determining under which conditions the lighted mouse pad alerts—the user's light alert activation preferences—are enabled;

FIG. 4 is a flowchart for determining whether to enable the light alert according to a user's preferences;

FIG. 5 is a flowchart describing the generation of a visible alert by a lighted mouse pad according to the type of event requiring user action;

FIG. 6 illustrates an information handling system which is a simplified example of a computer system capable of performing the computing operations described herein.

### DETAILED DESCRIPTION

The following is intended to provide a detailed description of an example of the invention and should not be taken to be limiting of the invention itself. Rather, any number of variations may fall within the scope of the invention defined in the claims following the description.

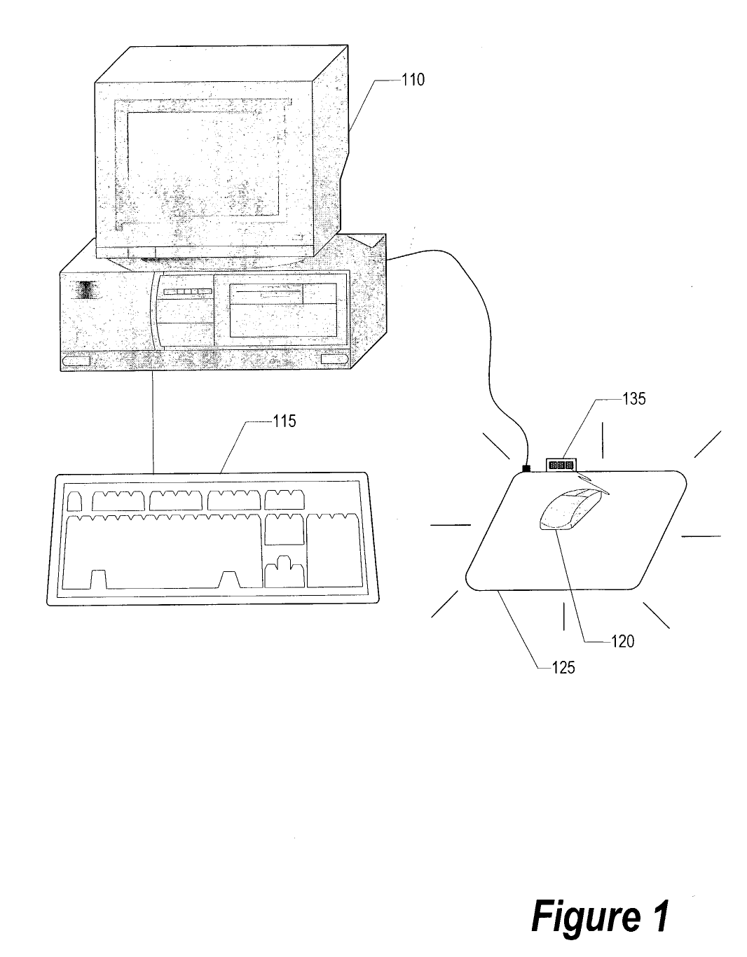

FIG. 1 is a diagram of a computer system having a lighted mouse pad that provides a user with visible alerts when an event requires user action. Computer 110 is connected to keyboard 115 for entering text and issuing commands and, through lighted mouse pad 125, to mouse 120, which is used as a pointing device. In one embodiment, keyboard 115 and lighted mouse pad 125 are connected to the computer's universal serial bus (USB) hub with USB cables. In one embodiment, lighted mouse pad 125 includes USB hub 135 for connecting additional USB devices such as mouse 120 to computer 110. A user can receive visible alerts about events requiring user action on computer 110 through lighted mouse pad 125. The lighted mouse pad can light up in different light alert modes according to the type of event requiring user action.

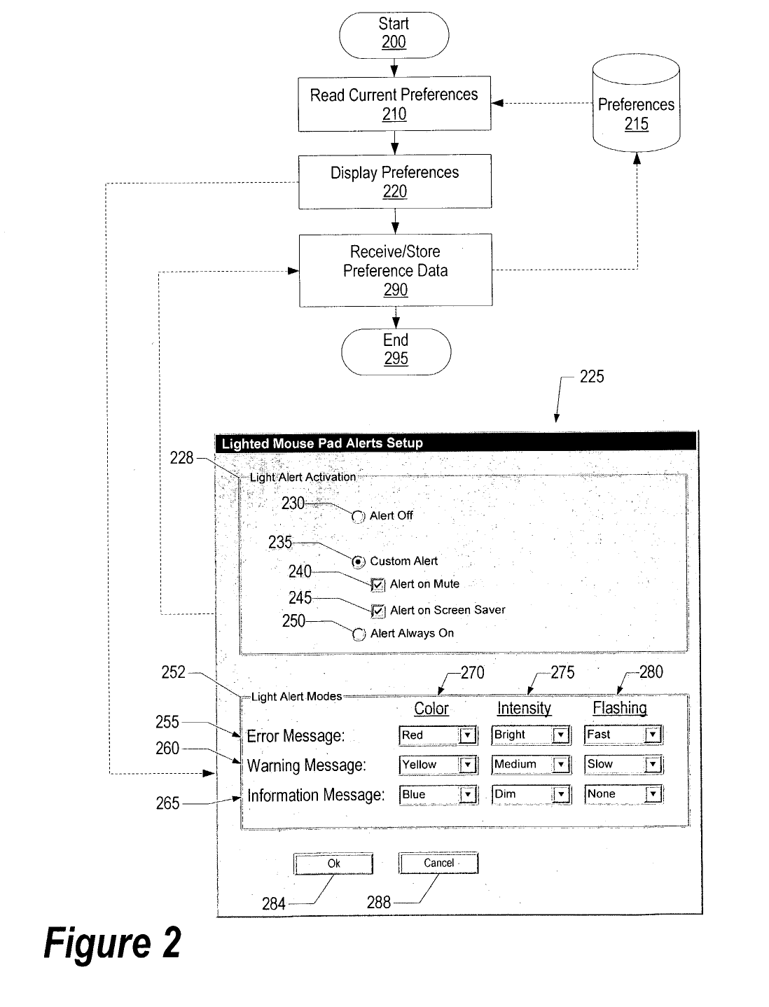

FIG. 2 is a flowchart for prompting a user to input the user's light alert activation and light alert modes preferences. Processing begins at 200 whereupon, at step 210, the user's current lighted mouse pad light alert activation and light alert modes preferences are read from preferences storage 215 stored on a nonvolatile storage device, such as a disk drive or nonvolatile memory. The user's light alert activation preferences indicate the conditions under which light alerts are enabled, and the light alert modes indicate which light alert mode corresponds to which type of event.

At step 220, the user's current preferences are displayed to the user through lighted mouse pad alerts setup window 225. Window 225 includes light alert activation group box 228 through which a user can change the light alert activation preferences and light alert activation group box 252 through which a user can change the light alert modes preferences.

The user has three main alert activation options. The user can completely disable the light alert by selecting “Alert Off” button 230. To enable the light alert under all conditions, the user can select “Alert On” button 250. The user can choose a custom alert by selecting “Custom Alert” button 235. The user can then check “Alert on Mute” checkbox 240 to enable the light alert only when the mute function is activated on the computer or the user can check “Alert on Screen Saver” checkbox 240 to enable the light alert only when the screen saver function is activated on the computer. The user may check both checkbox 240 and checkbox 245 to enable the light alert both when the mute function is activated and when the screen saver function is activated. The custom alert list may include additional conditions such as “Alert on Power Save”, etc.

For each of three event types, the user can choose three parameters to set a corresponding light alert mode. The light alert mode for “error messages” can be set by making selections in row 255; the light alert mode for “warning messages” can be set by making selections in row 260; and the light alert mode for “information messages” can be set by making selections in row 265. Additional types of events, such as “New Email Notification” and “Wrong Selection” can be added to the preferences window.

For each event type, a user may specify the color of the light by selecting a color in column 270, the intensity of the light by selecting an intensity value in column 275, and the flashing mode of the light by selecting a timing value in column 280. Other types of events may be added to event cues table 252 as necessary. In addition, the light alert modes may include additional parameters such as different light patterns, different sequence of LED flashing, etc.

After the user has finished making a selection, the user may select “OK” button 284 to accept and save the changes. If the user wishes to reject any changes made to the light alert preferences, the user may select “Cancel” button 288 to reject the changes and not save the changes. Processing ends at 295.

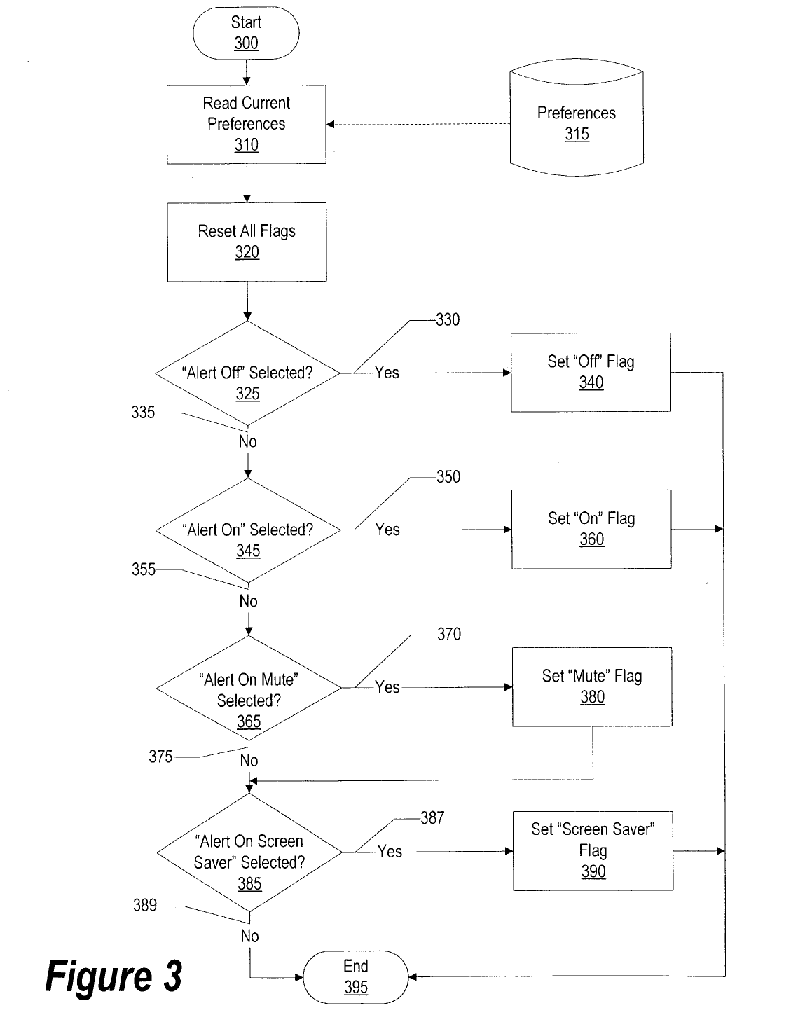

FIG. 3 is a flowchart for determining under which conditions the lighted mouse pad alerts—the user's light alert activation preferences—are enabled. Processing begins at 300 whereupon, at step 310, the user's selected preferences are read from preferences storage 315. At step 320, all flags used to indicate the user's current preferences are reset.

A determination is then made as to whether the “alert off” option had been selected by the user at decision 325. If the user had selected the “Alert Off” option, decision 325 branches to “yes” branch 330 whereupon the “Off” flag is set at step 340. Processing subsequently ends at 395.

If the user had not selected the “Alert Off” option, decision 325 branches to “no” branch 335 whereupon a determination is made as to whether the “Alert On” option had been selected by the user in decision 345. If the user had selected the “Alert On” option, decision 345 branches to “yes” branch 350 whereupon the “On” flag is set at step 360. Processing subsequently ends at 395.

If the user had not selected the “Alert On” option, decision 345 branches to “no” branch 355 whereupon a decision is made as to whether the user had selected “Alert on Mute” option in decision 365. If the user had selected the “Alert on Mute” option, decision 365 branches to “yes” branch 370 whereupon the “Mute” flag is set at step 380. Processing then continues at decision 385.

If the user had not selected the “Alert on Mute” option, decision 365 branches to “no” branch 375 whereupon a determination is made as to whether the user had selected the “Alert on Screen Saver” option in decision 385. If the user had selected the “Alert on Screen Saver” option, decision 385 branches to “yes” branch 387 whereupon the “Screen Saver” flag is set at step 390. Processing subsequently ends at 395. If the user had not selected the “Alert on Screen Saver” option, decision 385 branches to “no” branch 389 and processing ends at 395.

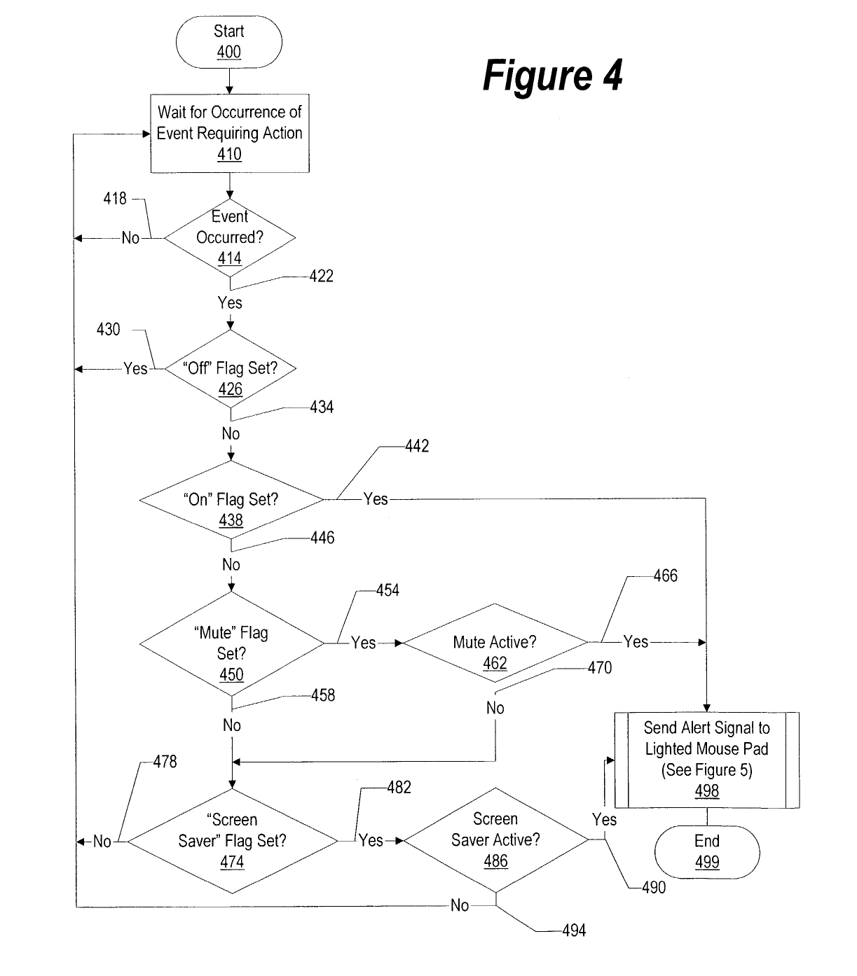

FIG. 4 is a flowchart for determining whether to enable the light alert according to a user's preferences. Processing begins at 400 whereupon, at step 410, the system waits for a new occurrence of an event requiring user action. A determination is then made as to whether the event has occurred at decision 414. If an event requiring user action has not occurred, decision 414 branches to “no” branch 418 whereupon the system returns to waiting for the occurrence of such event at step 410.

If an event requiring action has occurred, decision 414 branches to “yes” branch 422 whereupon a determination is made as to whether the “off” flag is set at decision 426. If the “off” flag is set, decision 426 branches to “yes” branch 430 whereupon the system returns to waiting for the occurrence of an event requiring user action at step 410.

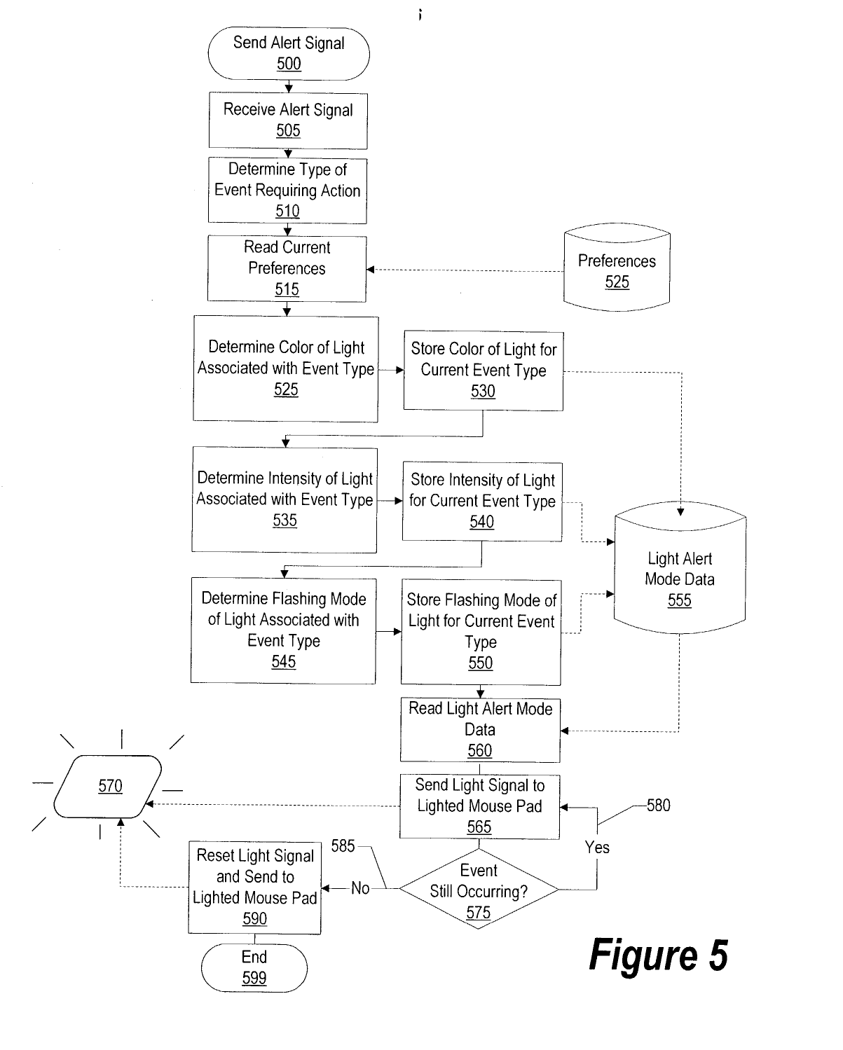

If the “off” flag is not set, decision 426 branches to “no” branch 434 whereupon a determination is made as to whether the “on” flag is set in decision 438. If the “on” flag is set, decision 438 branches to “yes” branch 442 whereupon, at step 498, an alert signal is sent to the lighted mouse pad. Step 498 is described in more detail in FIG. 5.

If the “on” flag is not set, decision 438 branches to “no” branch 446 whereupon a determination is made as to whether the “mute” flag is set in decision 450. If the “mute” flag is set, decision 450 branches to “yes” branch 454 whereupon a determination is made as to whether the mute function is active in decision 462. If the mute function is active, decision 462 branches to “yes” branch 466 whereupon, at step 498, an alert signal is sent to the lighted mouse pad. If the mute function is not active, decision 462 branches to “no” branch 470 and processing continues at decision 474.

If the “mute” flag is not set, decision 450 branches to “no” branch 458 whereupon a determination is made as to whether the “screen saver” flag is set in decision 474. If the “screen saver” flag is not set, decision 474 branches to “no” branch 478 whereupon the system returns to waiting for the occurrence of an event requiring user action at step 410.

If the “screen saver” flag is set, decision 474 branches to “yes” branch 483 whereupon a determination is made as to whether the screen saver function is active in decision 486. If the screen saver function is not active, decision 486 branches to “no” branch 494 whereupon the system returns to waiting for the occurrence of an event requiring user action at step 410. If the screen saver function is active, decision 486 branches to “yes” branch 490 whereupon, at step 498, an alert signal is sent to the lighted mouse pad. When the user no longer wishes to use lighted mouse-pad controls, processing ends at 499.

FIG. 5 is a flowchart describing the generation of a visible alert by a lighted mouse pad according to the type of event requiring user action. Processing begins at 500 whereupon an alert signal is received at step 505. The type of event requiring action is then determined from the received alert signal at step 510. The type of event may be, for example: an error message, a warning message, an information message, etc.

At step 520, the current user preferences are read from preferences storage 515. Preferences storage 515 contains light alert mode data for each type of event such as the color of the light to use in the alert, the intensity of the light, and flashing mode of the light.

At step 525, the color of the light associated with the type of the current event is determined, and at step 530, the color is stored in light alert mode data storage 555. Similarly, at step 535, the intensity of the light associated with the type of the current event is determined, and at step 540, the intensity is stored in light alert mode data storage 555. Finally, at step 545, the flashing mode of the light associated with the type of the current event is determined, and at step 550, the intensity is stored in light alert mode data storage 555.

At step 560, the stored light alert mode data is read from storage 555, and at step 565, an appropriate light alert signal is sent to lighted mouse pad 570. The light alert signal includes information obtained from storage 555. For example, the light alert signal may contain color, intensity, and flashing mode information.

A determination is then made as to whether the event requiring user action is still occurring in decision 575. If the event is still occurring, decision 575 branches to “yes” branch 580 and processing returns to step 565 whereupon the light alert signal is again sent to lighted mouse pad 570. If the event is not still occurring, decision 575 branches to “no” branch 585 whereupon, at step 590, a “reset light signal” command is sent to lighted mouse pad 570. The “reset light signal” command instructs lighted mouse pad 570 to stop emitting light as the event requiring user action is no longer occurring. Processing ends at 599.

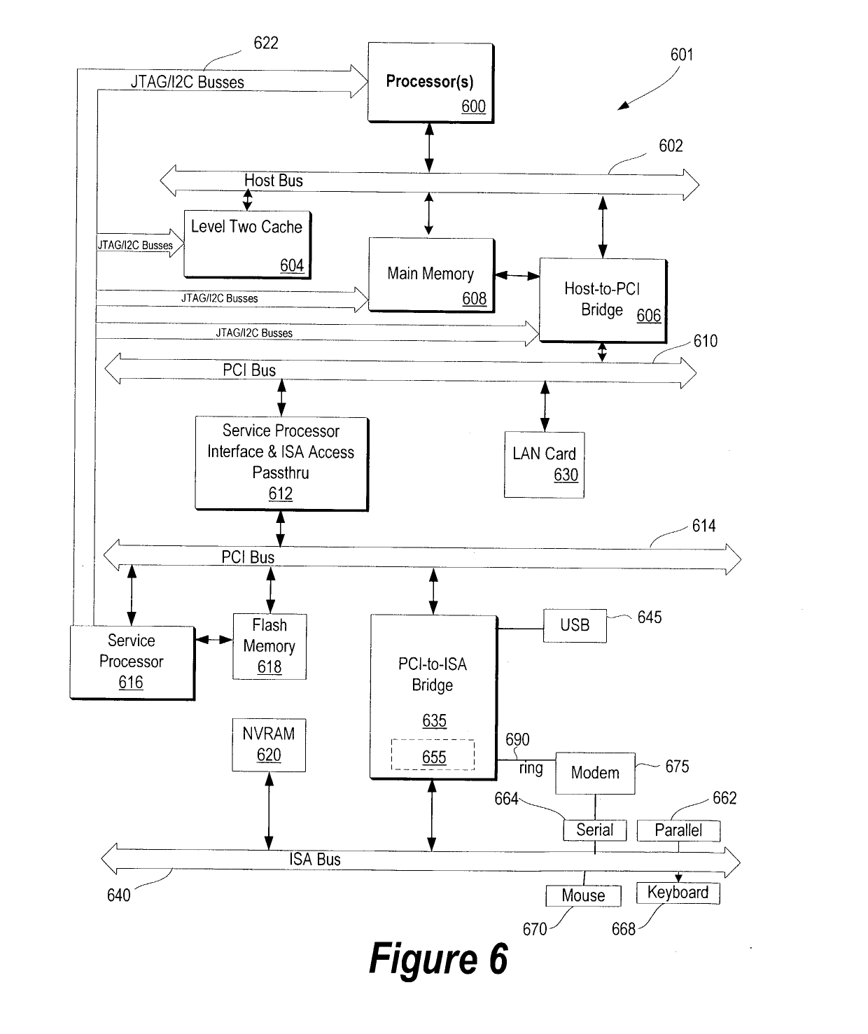

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and 12C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method for alerting a user of a computer system, the method comprising:
receiving a request to alert the user about an event;
determining a light alert mode corresponding to a type of the event; and
lighting a mouse pad according to the light alert mode.

2. The method of claim 1, wherein the determining the light alert mode comprises:
determining one or more light characteristics corresponding to the light alert mode, wherein at least one of the light characteristics is selected from the group consisting of a color, an intensity, and a flashing mode.

3. The method of claim 1, further comprising:
selecting an event type from a plurality of possible event types;
prompting the user for a light alert mode preference corresponding to the selected event type;
receiving the light alert mode preference for the selected event type; and
storing the selected light alert mode as the light alert mode corresponding to the type of the event.

4. The method of claim 1, further comprising:
identifying an alert activation preference; and
determining whether to perform the lighting based upon the identified alert activation preference.

5. The method of claim 4, further comprising:
prompting the user for the alert activation preference;
receiving the user's selected alert activation preference; and
storing the selected alert activation preference in a memory location, wherein the selected alert activation preference is retrieved prior to the lighting.

6. The method of claim 5, wherein the prompting comprises asking the user to select a preference from the group consisting of: “Alert Off”, “Alert on Mute”, “Alert on Screen Saver”, “Custom Alert”, and “Alert On”.

7. The method of claim 1, wherein the light alert mode is selected from the group consisting of an error message, a warning message, and an informational message.

8. An information handling system comprising:
one or more processors;
a memory accessible by the processors;
a lighted mouse pad accessible by the processors,
wherein the lighted mouse pad includes one or more lights;
a nonvolatile storage device accessible by the processors; and
a tool for alerting a user of the information handling system, the tool being effective to:
receive a request to alert the user about an event;
determine a light alert mode corresponding to a type of the event; and
activate at least one of the lighted mouse pad lights according to the light alert mode.

9. The information handling system of claim 8, wherein, to determine the light alert mode, the tool is further effective to:
determine one or more light characteristics corresponding to the light alert mode, wherein at least one of the light characteristics is selected from the group consisting of a color, an intensity, and a flashing mode.

10. The information handling system of claim 8, wherein the tool is further effective to:
select an event type from a plurality of possible event types;
prompt the user for a light alert mode preference corresponding to the selected event type;
receive the light alert mode preference for the selected event type; and
store the selected light alert mode as the light alert mode corresponding to the type of the event.

11. The information handling system of claim 8, wherein the tool is further effective to:
identify an alert activation preference; and
determine whether to perform the lighting based upon the identified alert activation preference.

12. The information handling system of claim 11, wherein the tool is further effective to:
prompt the user for the alert activation preference;
receive the user's selected alert activation preference; and
store the selected alert activation preference in a memory location, wherein the selected alert activation preference is retrieved prior to the lighting.

13. The information handling system of claim 12, wherein to prompt the user, the tool is further effective to ask the user to select a preference from the group consisting of: “Alert Off”, “Alert on Mute”, “Alert on Screen Saver”, “Custom Alert”, and “Alert On”.

14. The information handling system of claim 8, wherein the lighted mouse pad includes a USB hub, the USB hub including at least one USB interface adapted to connect at least one USB device to the information handling system through the USB interface.

15. A computer program product stored in a computer operable media for alerting a user of a computer system, wherein the computer program product is adapted to:
receive a request to alert the user about an event;
determine a light alert mode corresponding to a type of the event; and
activate at least one of the mouse pad lights according to the light alert mode.

16. The computer program product of claim 15, wherein, to determine the light alert mode, the tool is further adapted to:
determine one or more light characteristics corresponding to the light alert mode, wherein at least one of the light characteristics is selected from the group consisting of a color, an intensity, and a flashing mode.

17. The computer program product of claim 15, wherein the computer program product is further adapted to:
select an event type from a plurality of possible event types;
prompt the user for a light alert mode preference corresponding to the selected event type;
receive the light alert mode preference for the selected event type; and
store the selected light alert mode as the light alert mode corresponding to the type of the event.

18. The computer program product of claim 15, wherein the computer program product is further adapted to:
identify an alert activation preference; and
determine whether to perform the lighting based upon the identified alert activation preference.

19. The computer program product of claim 18, wherein the computer program product is further adapted to:
prompt the user for the alert activation preference;
receive the user's selected alert activation preference; and
store the selected alert activation preference in a memory location, wherein the selected alert activation preference is retrieved prior to the lighting.

20. The computer program product of claim 19, wherein to prompt the user, the computer program product is further adapted to ask the user to select a preference from the group consisting of: “Alert Off”, “Alert on Mute”, “Alert on Screen Saver”, “Custom Alert”, and “Alert On”.

21. The computer program product of claim 15, wherein the light alert mode is selected from the group consisting of an error message, a warning message, and an informational message.

22. A computer-implemented method for alerting a user of a computer system, the method comprising:
receiving an alert activation preference from the user;
identifying an event occurring in the computer system;
determining a light alert mode corresponding to a type of the event; and
lighting a mouse pad according to the light alert mode, wherein the lighting is performed in response to the alert activation preference being set to an active mode.

23. An information handling system comprising:
one or more processors;
a memory accessible by the processors;
a lighted mouse pad accessible by the processors, wherein the lighted mouse pad includes one or more lights;
a nonvolatile storage device accessible by the processors; and
a tool for alerting a user of the information handling system, the tool being effective to:
receive an alert activation preference from the user;
identify an event occurring in the computer system;
determine a light alert mode corresponding to a type of the event; and
light one or more lights on the lighted mouse pad according to the light alert mode and in response to the alert activation preference being set to an active mode.

24. A computer program product stored in a computer operable media for alerting a user of a computer system, wherein the computer program product is adapted to:
receive an alert activation preference from the user;
identify an event occurring in the computer system;
determine a light alert mode corresponding to a type of the event; and
light one or more lights on the lighted mouse pad according to the light alert mode and in response to the alert activation preference being set to an active mode.
